(19) United States
(12) Patent Application Publication
(10) Pub. No.: US 2023/0354479 A1
(43) Pub. Date: Nov. 2, 2023

(54) HEATER ELEMENT FOR HEATING VEHICLE CABIN, HEATER UNIT, HEATER SYSTEM, AND HEATER ELEMENT FOR PURIFYING VEHICLE CABIN

(71) Applicant: NGK INSULATORS, LTD., Nagoya-City (JP)

(72) Inventors: Yukio MIYAIRI, Nagoya-Shi (JP); Masaaki MASUDA, Nagoya-Shi (JP); Yoshifumi TAKAGI, Chiryu-Shi (JP); Hirofumi YAMAGUCHI, Komaki-Shi (JP); Toru HAYASE, Nagoya-Shi (JP); Takuya NAKASHIMA, Nagoya-Shi (JP)

(73) Assignee: NGK INSULATORS, LTD., Nagoya-City (JP)

(21) Appl. No.: 18/349,345

(22) Filed: Jul. 10, 2023

Related U.S. Application Data
(63) Continuation of application No. PCT/JP2021/033211, filed on Sep. 9, 2021.

(30) Foreign Application Priority Data
Jan. 15, 2021 (JP) 2021-005358

(51) Int. Cl. H05B 3/03; B60H 1/22; H05B 3/50

(52) U.S. Cl. CPC H05B 3/03; B60H 1/2225; H05B 3/50; H05B 2203/024; H05B 2203/023; H05B 2203/02

(57) ABSTRACT

A heater element includes: a honeycomb structure having an outer peripheral wall and partition walls disposed on an inner side of the outer peripheral wall, the partition walls defining a plurality of cells each forming a flow path from a first end face to a second end face, the outer peripheral wall and the partition walls made of a material having a PTC property; and a pair of electrode layers provided on a surface of the outer peripheral wall. The honeycomb structure has a shape having a long axis and a short axis in a cross section orthogonal to a central axis.

### CROSS REFERENCE TO RELATED APPLICATIONS

The present invention claims the benefit of priorities to Japanese Patent Application No 2021-005358 filed on Jan. 15, 2021 and PCT Patent Application No. PCT/JP2021/033211 filed on Sep. 9, 2021, the entire contents of which are incorporated herein by reference in its entirety.

### FIELD OF THE INVENTION

The present invention relates to a heater element for heating a vehicle cabin, a heater unit, a heater system, and a heater element for purifying a vehicle cabin.

### BACKGROUND OF THE INVENTION

In recent years, a heater system has been used as a heater system for heating a vehicle cabin of an electric vehicle. The heater system uses a vapor compression heat pump as a main heater, while supplementarily using a heater utilizing Joule heat when rapid heating is required at the start of the vehicle or when the outside temperature is extremely low.

As the heater utilizing Joule heat used in the heater system, Patent Literature 1 proposes a heater element using a honeycomb structure that is compact and capable of increasing a heat transfer area per unit volume. The heater element includes: a honeycomb structure having an outer peripheral wall, partition walls disposed on an inner side of the outer peripheral wall, the partition walls defining a plurality of cells, each cell forming a flow path from a first end face to a second end face; and a pair of electrode layers disposed on the first end face and the second end face, wherein the heater element can generate heat by applying a voltage between the pair of electrodes to conduct electricity in a direction of the flow path.

However, the heater element described in Patent Literature 1 cannot have sufficient reliability, because the electrodes face the flow path of the gas, causing a risk that the electrodes are corroded.

Therefore, Patent Literature 2 proposes a heater element having a pair of electrode layers arranged on a surface of an outer peripheral wall of a honeycomb structure. This heater element can suppress the corrosion of the electrode layers, because the electrode layers do not face the flow path of the gas.

### PRIOR ART

### Patent Literatures

[PTL 1]
WO 2020/036067 A1
[PTL 2]
Japanese Patent Application Publication No. 2020-59443 A

### SUMMARY OF THE INVENTION

The present invention relates to a heater element for heating a vehicle cabin, comprising:
a honeycomb structure comprising: an outer peripheral wall; and partition walls disposed on an inner side of the outer peripheral wall, the partition walls defining a plurality of cells each forming a flow path from a first end face to a second end face, the outer peripheral wall and the partition walls comprising a material having a PTC property; and
a pair of electrode layers provided on a surface of the outer peripheral wall,
wherein the honeycomb structure has a shape having a long axis and a short axis in a cross section orthogonal to a central axis,
wherein the pair of electrode layers are formed in a band shape extending parallel to the central axis, and are arranged on the surface of the outer peripheral wall so as to face each other across the long axis passing through a center of gravity of the honeycomb structure in the cross section orthogonal to the central axis, and
wherein the heater element further comprises a plate-shaped external connecting member disposed on an end portion side of each of the electrode layers, the plate-shaped external connecting member being in plane contact with each of the electrode layers.

Further, the present invention provides a heater unit for heating a vehicle cabin, the heater unit comprising two or more of the heater elements,
wherein the heater elements are stacked so that surfaces of the outer peripheral walls of the honeycomb structures, including long sides of the first end faces and the second end faces, are opposed to each other.

The present invention also relates to a heater system for heating a vehicle cabin, comprising:
the heater unit;
an inflow pipe for communicating an outside air introduction portion or a vehicle cabin with an inflow port of the heater unit;
a battery for applying voltage to the heater unit; and
an outflow pipe for communicating an outflow port of the heater unit with the vehicle cabin.

Further, the present invention relates to a heater element for purifying a vehicle cabin, comprising:
a honeycomb structure comprising: an outer peripheral wall; and partition walls disposed on an inner side of the outer peripheral wall, the partition walls defining a plurality of cells each forming a flow path from a first end face to a second end face, the outer peripheral wall and the partition walls comprising a material having a PTC property;
a pair of electrode layers provided on a surface of the outer peripheral wall; and
a functional material-containing layer provided on surfaces of the partition walls,
wherein the honeycomb structure has a shape having a long axis and a short axis in a cross section orthogonal to a central axis,
wherein the pair of electrode layers are formed in a band shape extending parallel to the central axis, and are arranged on the surface of the outer peripheral wall so as to face each other across the long axis passing through a center of gravity of the honeycomb structure in the cross section orthogonal to the central axis, and
wherein the heater element further comprises a plate-shaped external connecting member disposed on an end portion side of each of the electrode layers, the plate-shaped external connecting member being in plane contact with each of the electrode layers.

### BRIEF DESCRIPTION OF THE DRAWINGS

FIG. 1 is a schematic perspective view of a heater element according to an embodiment of the invention;

FIG. 2 is a schematic cross-sectional view of the heater element of FIG. 1, which is orthogonal to a central axis of a honeycomb structure;

FIG. 3 is a schematic cross-sectional view of another heater element according to an embodiment of the present invention, which is orthogonal to a central axis of a honeycomb structure;

FIG. 4 is a schematic cross-sectional view of another heater element according to an embodiment of the present invention, which is orthogonal to a central axis of a honeycomb structure;

FIG. 5 is a schematic cross-sectional view of another heater element according to an embodiment of the present invention, which is orthogonal to a central axis of a honeycomb structure;

FIG. 6 is a schematic cross-sectional view of another heater element according to an embodiment of the present invention, which is orthogonal to a central axis of a honeycomb structure;

FIG. 7 is a partially enlarged view of a honeycomb structure in the heater element of FIG. 2;

FIG. 8 is a schematic cross-sectional view of a honeycomb joined body having five honeycomb segments, which is orthogonal to a central axis;

FIG. 9 is a schematic partial enlarged cross-sectional view of another heater element according to an embodiment of the present invention, which is orthogonal to a central axis of a honeycomb structure;

FIG. 10 is a schematic front view of a heater unit according to an embodiment of the present invention as viewed from a first end face side of a heater element;

FIG. 11 is a schematic front view of another heater unit according to an embodiment of the present invention as viewed from a first end face side of the heater element;

FIG. 12 is a schematic front view of another heater unit according to an embodiment of the present invention as viewed from a first end face side of the heater element;

FIG. 13 is a schematic view showing an arrangement example of a heater system according to an embodiment of the present invention;

FIG. 14 is a schematic cross-sectional view of a honeycomb joined body of a heater element produced in Example 1, which is orthogonal to a central axis;

FIG. 15 is a schematic view of an evaluation box used in Examples; and

FIGS. 16A and 16B show current density distribution results for heater elements produced in Examples 1 and 2.

### DETAILED DESCRIPTION OF THE INVENTION

The heater element described in Patent Literature 2 connects the electrode layers to the outside (for example, a battery) by electric wires. This heater element has a problem that an amount of electric power supplied from the outside is limited because of a smaller contact area between the electric wire and the electrode layer, resulting in insufficient heat generation performance. Also, the honeycomb structure used in the heater element of Patent Literature 2 is made of a material that does not have PTC properties, and controls the current by an increase in electrical resistance due to an increase in a temperature of the PTC material layer in contact with the outer peripheral wall of the honeycomb structure. Therefore, the sensitivity of temperature control is also lower than when the honeycomb structure is made of a material having PTC properties.

The present invention has been made to solve the problems as described above. An object of the present invention is to provide a heater element for heating a vehicle cabin, which can increase an amount of power supplied from the outside and improve heat generation performance, and a heater unit and a heater system for heating a vehicle cabin using that heater element. Also, another object of the present invention is to provide a heater element which can also be used for purifying a vehicle cabin.

According to the present invention, it is possible to provide a heater element for heating a vehicle cabin, which can increase an amount of power supplied from the outside and improve heat generation performance, as well as a heater unit and a heater system for heating a vehicle cabin using that heater element. Also, according to the present invention, it is possible to provide a heater element which can also be used for purifying a vehicle cabin.

Hereinafter, embodiments of the present invention will be specifically described with reference to the drawings. It is to understand that the present invention is not limited to the following embodiments, and those which have appropriately added changes, improvements and the like to the following embodiments based on knowledge of a person skilled in the art without departing from the spirit of the present invention fall within the scope of the present invention.

### (1. Heater Element)

A heater element according to an embodiment of the present invention can be suitably utilized as a heater element for heating a vehicle cabin of a vehicle. The vehicle includes, but not limited to, automobiles and electric railcars. Non-limiting examples of the automobiles include a gasoline vehicle, a diesel vehicle, a gas fuel vehicle using CNG (a compressed natural gas) or LNG (a liquefied natural gas), a fuel cell vehicle, an electric vehicle, and a plug-in hybrid vehicle. The heater element according to the embodiment of the present invention can be particularly suitably used for a vehicle having no internal combustion engine such as electric vehicles and electric railcars.

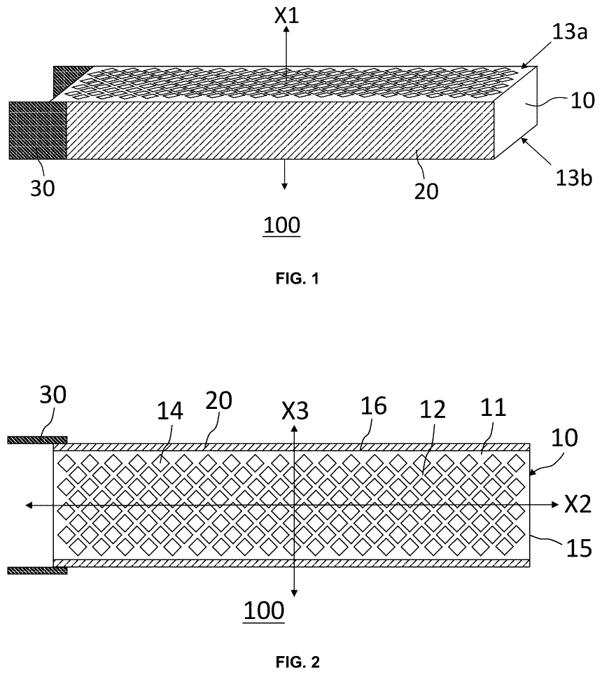

FIG. 1 is a schematic perspective view of a heater element according to an embodiment of the invention. FIG. 2 is a schematic cross-sectional view of the heater element of FIG. 1.

A heater element 100 according to an embodiment of the present invention includes: a honeycomb structure 10 having an outer peripheral wall 11 and partition walls 12 disposed on an inner side of the outer peripheral wall 11, the partition walls 12 defining a plurality of cells 14 each forming a flow path from a first end face 13a to a second end face 13b; and a pair of electrode layers 20 disposed on a surface of the outer peripheral wall 11. The honeycomb structure 10 has a shape having a long axis X2 and a short axis X3 in a cross section orthogonal to a central axis X1. The pair of electrode layers 20 are formed in a band shape extending parallel to the central axis X1, and are arranged on the surface of the outer peripheral wall 11 so as to face each other across the long axis X2 passing through a center of gravity of the honeycomb structure 10 in the cross section orthogonal to the central axis X1. Also, the heater element 100 further includes a plate-shaped external connecting member 30 which is disposed on an end portion side of each of the electrode layers 20, and which is in plane contact with each of the electrode layers 20. By thus arranging the electrode layers 20 and the external connecting members 30, the electrode layers 20 and the external connecting members 30 are in surface contact, and an amount of power supplied from the outside can be easily increased, so that the heat generation performance can be improved.

Each member making up the heater element 100 will be described below in detail.

### (1-1. Honeycomb Structure 10)

The honeycomb structure 10 is not particularly limited as long as it has a shape having the long axis X2 and the short axis X3 in the cross section orthogonal to the central axis X1. As the shape of the honeycomb structure 10, for example, the cross section (outer shape) orthogonal to the central axis X1 can be rectangular, oval (egg-shaped, elliptical, elliptic, rounded rectangular, etc.), polygonal (hexagon, octagon, and the like, having at least two opposite sides longer than the other sides), and the like. Among these, the cross section is preferably rectangular. It should be noted that the end faces (first end face 13a and second end face 13b) have the same shape as the cross section.

When the cross section is rectangular, the cross section has short sides 15 and long sides 16. The pair of electrode layers 20 are arranged on both surfaces of the outer peripheral wall 11 including the long sides 16.

A ratio of the length of the short side 15 to the length of the long side 16 is preferably 1:2 to 1:15, and more preferably 1:2 to 1:10, and even more preferably 1:3 to 1:8, although not particularly limited thereto. The control of the ratio to such a range allows the size of the honeycomb structure to be easily matched to the size of the heater element used in existing heater unit.

The length of the long side 16 can be, for example, 30 mm to 250 mm. Also, the length of the short side 15 can be, for example, 5 mm to 200 mm. In particular, a reduced distance between the pair of electrode layers 20 so as to have a length of the short side 15 of 10 mm or less allows for heating even at a low voltage of about 10V.

The shape of each cell 14 in the cross section orthogonal to the central axis X1 is not limited, but it may preferably be a quadrangle (rectangle, square), a hexagon, an octagon, or a combination thereof. Among these, the quadrangle and hexagon are preferable, and hexagon is more preferable. By forming the cells 14 into such a shape, it is possible to reduce the pressure loss during passing of a gas.

It should be noted that FIG. 1 and FIG. 2 are examples of the honeycomb structure 10 in which, in the cross section orthogonal to the central axis 1, the cross section is rectangular and the shape of each cell 14 is square.

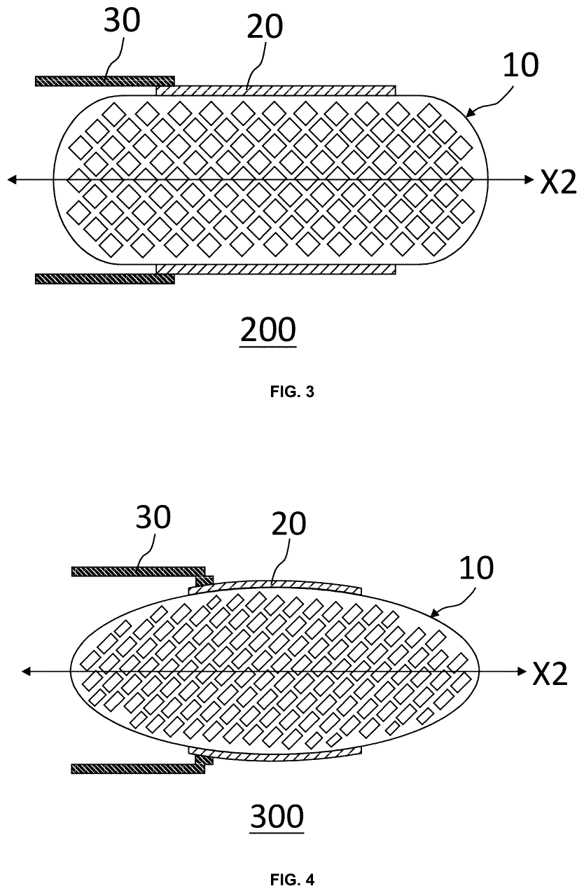

Here, FIGS. 3 to 6 show examples of heater elements provided with honeycomb structures 10 having other shapes.

FIG. 3 shows an example of a heater element 200 including a honeycomb structure 10 in which, in cross section perpendicular to the central axis X1, the cross section is a rounded rectangle (racetrack shaped) and each cell 14 is square.

FIG. 4 shows an example of a heater element 300 including a honeycomb structure 10 in which, in cross section perpendicular to the central axis X1, the cross section is elliptical and each cell 14 is rectangular.

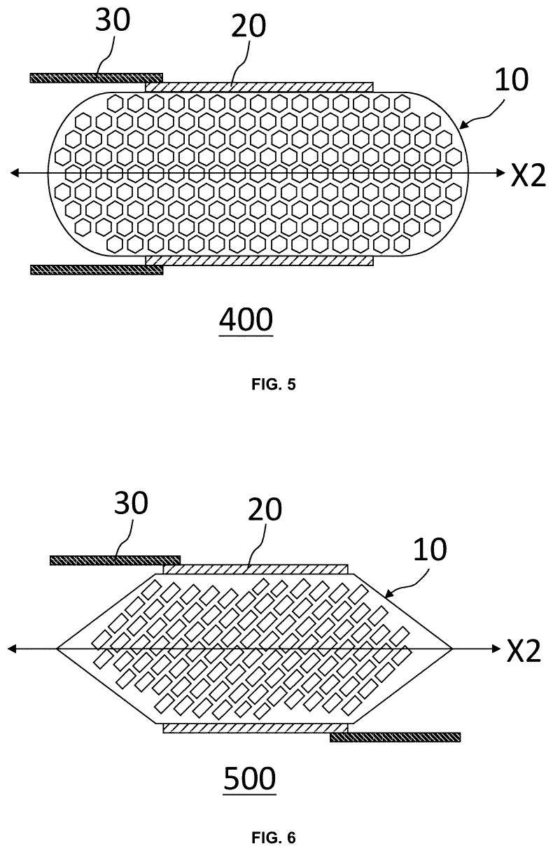

FIG. 5 shows an example of a heater element 400 including a honeycomb structure 10 in which, in a cross section perpendicular to the central axis X1, the cross section is a rounded rectangle (racetrack shape) and each cell 14 is hexagonal.

FIG. 6 shows an example of a heater element 500 including a honeycomb structure 10 in which, in a cross section orthogonal to the central axis X1, the cross section has a hexagonal shape in which two opposing sides provided with the electrode layers 20 are longer than the other sides, and each cell 14 is rectangular.

Each of the heater elements 200, 300, 400, and 500 described above is provided with a pair of heater elements 20 on the surface of the outer peripheral wall 11 so as to face each other across the long axis X2 passing through the center of gravity of the honeycomb structure 10 in the cross section orthogonal to the central axis X1, and is provided with the plate-shaped external connecting member 30 on the end portion side of each electrode layer 20 so as to be in plane contact with each electrode layer 20.

Although the heater element 100 will be mainly described below, the same descriptions apply to the heater elements 200, 300, 400, and 500.

The honeycomb structure 10 preferably does not have the partition walls 12 parallel to the long axis X2 in the cross section orthogonal to the central axis X1. Such a configuration allows the cells 14 to be uniformly heated during use, and also allows deformation and cracking of the cells 14 to be suppressed.

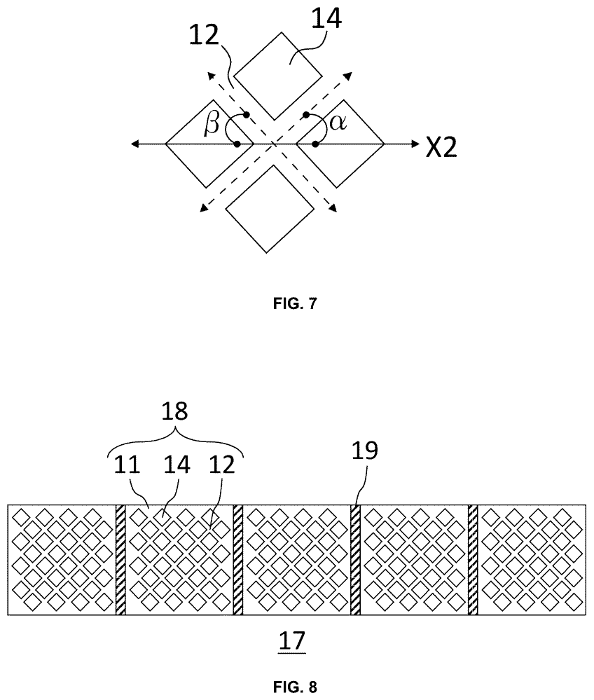

Here, FIG. 7 shows a partially enlarged view of the honeycomb structure 10 in the heater element 100 of FIG. 2. As shown in FIG. 7, the partition walls 12 have angles α and β with respect to the long axis X2. The angles α and β are preferably 30 to 60°. By controlling the angles α and β of the partition walls 12 with respect to the long axis X2 to the above ranges, the effect of suppressing deformation and cracking of the cells 14 during use with heating can be stably obtained.

The honeycomb structure 10 may be a honeycomb joined body having a plurality of honeycomb segments and joining layers for joining the plurality of honeycomb segments to each other. The use of the honeycomb joined body can lead to an increase in the total cross-sectional area of the cells 14, which is important for ensuring a gas flow rate, while suppressing the generation of cracks.

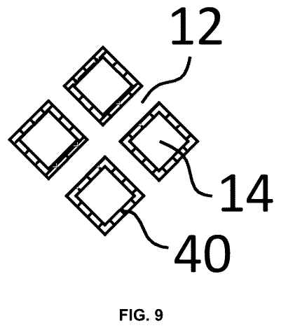

Here, as an example, FIG. 8 shows a schematic cross-sectional view of a honeycomb joined body having five honeycomb segments, which is orthogonal to the central axis X1.

As shown in FIG. 8, the honeycomb joined body 17 has the five honeycomb segments 18 and the joining layers 19 for joining the honeycomb segments 18 to each other. Each honeycomb segment 18 has the outer peripheral wall 11 and the partition walls 12 disposed on the inner side of the outer peripheral wall 11 and defining the plurality of cells 14 each forming a flow path from the first end face 13a to the second end face 13b.

Each joining layer 19 can be formed by using a joining material. The joining material is not particularly limited, but a paste-like ceramic material obtained by adding a solvent such as water can be used. The joining material may contain ceramics having a PTC property, or may contain the same ceramics as the outer peripheral wall 11 and the partition walls 12. In addition to the role of joining the honeycomb segments 18 to each other, the joining material can also be used as an outer peripheral coating material after joining the honeycomb segments 18.

An area of each end face of the honeycomb structure 10 is can be, for example, 20 to 500 cm², although not particularly limited thereto. Also, a length of the honeycomb structure 10 (flow path length of each cell 14) can be, for example, 3 to 40 mm, although not particularly limited thereto.

### (1-1-1. Material of Honeycomb Structure 10)

The outer peripheral wall 11 and the partition walls 12 of the honeycomb structure 10 are formed of a material that can generate heat by electrical conduction. Therefore, a gas such as outside air or vehicle cabin air can be heated by heat transfer from the heating outer peripheral wall 11 and partition walls 12 while the gas flows in the first end face 13a, passes through the plurality of cells 14, and flows out from the second end face 13b.

Further, the outer peripheral wall 11 and the partition walls 12 are composed of a material having a PTC (Positive Temperature Coefficient) property. That is, the outer peripheral wall 11 and the partition walls 12 have a property that, as the temperature is increased to exceed the Curie point, a resistance value is rapidly increased, resulting in difficulty for electricity to flow. Since the outer peripheral wall 11 and the partition walls 12 have the PTC property, the current flowing through them is limited when the heater element 100 becomes hot, so that excessive heat generation of the heater element 100 is prevented.

From the viewpoint of being able to generate heat upon the electrical conduction and of having the PTC property, the outer peripheral wall 11 and the partition walls 12 are preferably formed of ceramics made of a material containing barium titanate (BaTiO₃)-based crystalline particles in which a part of Ba is substituted with a rare earth element(s), as a main component. As used herein, the term “main component” means a component in which a proportion of the component to the total component is more than 50% by mass. The content of the BaTiO₃-based crystalline particles can be determined by, for example, fluorescent X-ray analysis, EDAX (energy dispersive X-ray) analysis, or the like.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.0001≤x≤0.010.

The symbol A is not particularly limited as long as it is the rare earth element, but it may preferably be one or more selected from the group consisting of Sc, Y, La, Ce, Pr, Nd, Eu, Gd, Dy, Ho, Er and Yb, and more preferably La. The x value is preferably 0.001 or more, and more preferably 0.0015 or more, and even more preferably 0.002 or more, in terms of suppressing excessively high electrical resistance at room temperature. On the other hand, x is preferably 0.001 or less, and more preferably 0.009 or less, and even more preferably 0.008 or less, in terms of preventing the electrical resistance at room temperature from becoming too high due to insufficient sintering.

The BaTiO₃-based crystalline particles in which a part of Ba is substituted with the rare earth element preferably have a (Ba+rare earth element)/Ti ratio of 1.005 to 1.050. By controlling the (Ba+rare earth element)/Ti ratio to such a range, the electrical resistance at room temperature can be stably reduced. The element ratio of Ba, the rare earth element, and Ti can be determined by, for example, X-ray fluorescence analysis and ICP-MS (inductively coupled plasma mass spectrometry).

The BaTiO₃-based crystalline particles in which a part of Ba is substituted with the rare earth element preferably have an average crystal grain size of from 5 to 200 μm, and more preferably from 5 to 180 μm, and even more preferably from 5 to 160 μm. By controlling the average crystal grain size to such a range, the electrical resistance at room temperature can be stably reduced.

The average crystal grain size of the BaTiO₃-based crystalline particles can be measured as follows. A square sample having 5 mm×5 mm×5 mm is cut out from the ceramics and encapsulated with a resin. The encapsulated sample is mirror-polished by mechanical polishing and observed by SEM. The SEM observation is carried out using, for example, a model S-3400N from Hitachi High-Tech Corporation, at an acceleration voltage of 15 kV and at magnifications of 3000. In the SEM observation image (30 μm in length×45 μm in width), four straight lines each having a thickness of 0.3 μm were drawn at intervals of 10 μm across the entire vertical direction of the field of view, and the number of BaTiO₃-based crystalline particles through which these lines pass even at a part of them is counted. An average of the SEM images at four or more positions where the length of the straight line is divided by the number of BaTiO₃-based crystalline particles is defined as the average crystal grain size.

The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

The content of the BaTiO₃-based crystalline particles can be measured by, for example, fluorescent X-ray analysis or EDAX (energy dispersive X-ray) analysis. Other crystalline particles can be measured in the same manner as this method.

The ceramics used for the outer peripheral wall 11 and the partition walls 12 preferably contains Ba₆Ti₁₇O₄₀ crystalline particles. The presence of Ba₆Ti₁₇O₄₀ crystalline particles in the ceramics can reduce the electrical resistance at room temperature. Although not wishing to be bound by any theory, it is believed that Ba₆Ti₁₇O₄₀ crystalline particles are liquefied during a firing process to promote rearrangement, grain growth and densification of BaTIO₃-based crystalline particles, thus reducing the electrical resistance at room temperature.

The content of the Ba₆Ti₁₇O₄₀ crystalline particles in the ceramics may be from 1.0 to 10.0% by mass, and preferably from 1.2 to 8.0% by mass, and even more preferably from 1.5 to 6.0% by mass. The content of the Ba₆Ti₁₇O₄₀ crystalline particles of 1.0% by mass or more can provide an effect of the presence of the Ba₆Ti₁₇O₄₀ crystalline particles (i.e., an effect of reducing the electric resistance at room temperature). Further, the content of the Ba₆Ti₁₇O₄₀ crystalline particles of 10.0% by mass or less can ensure the PTC property.

The ceramics used for the outer peripheral wall 11 and the partition walls 12 can further contain BaCO₃ crystalline particles. The BaCO₃ crystalline particles are those derived from BaCO₃ powder, which is a raw material for the ceramics.

The BaCO₃ crystalline particles may not be contained in the ceramics because they have substantially no effect on the electrical resistance of the ceramics at room temperature. However, if the content of BaCO₃ crystalline particles in the ceramics is too high, it may affect the electrical resistance at room temperature, and the number of other crystalline particles may decrease, so that desired properties may not be obtained. Therefore, the content of the BaCO₃ crystalline particles is preferably 2.0% by mass or less, and more preferably 1.8% by mass or less, and further preferably 1.5% by mass or less. The lower limit of the content of BaCO₃ crystalline particles is not particularly limited, but it may generally be 0.1% by mass, and preferably 0.2% by mass.

The ceramics used for the outer peripheral wall 11 and the partition walls 12 may further contain a component(s) conventionally added to PTC materials, in addition to the above crystalline particles. Such a component includes additives such as shifters, property improving agents, metal oxides and conductor powder, as well as unavoidable impurities.

In terms of reduction of the environmental load, it is desirable that the ceramics used for the outer peripheral wall 11 and the partition walls 12 is substantially free of lead (Pb). More particularly, the ceramics preferably has a Pb content of 0.01% by mass or less, and more preferably 0.001% by mass or less, and still more preferably 0% by mass. The lower Pb content can allow heated air to be safely applied to organisms such as humans by contacting the ceramics, for example. In the ceramics, the Pb content is preferably less than 0.03% by mass, and more preferably less than 0.01% by mass, and further preferably 0% by mass, as converted to PbO. The lead content can be determined by, for example, fluorescent X-ray analysis, ICP-MS (inductively coupled plasma mass spectrometry), or the like.

It is preferable that the ceramics used for the outer peripheral wall 11 and the partition walls 12 is substantially free of an alkali metal which may affect the electric resistance at room temperature. More particularly, the ceramics preferably has an alkali metal content of 0.01% by mass or less, and more preferably 0.001% by mass or less, and still more preferably 0% by mass. By controlling the content of the alkali metal to such a range, the electrical resistance at room temperature can be stably reduced. The alkali metal content can be determined by, for example, fluorescent X-ray analysis, ICP-MS (inductively coupled plasma mass spectrometry), or the like.

The material making up the outer peripheral wall 11 and the partition walls 12 preferably have a Curie point of 100° C. or more, and more preferably 110° C. or more, and even more preferably 125° C. or more, in terms of efficiently heating the air for a heating application. Further, the upper limit of the Curie point is preferably 250° C., and preferably 225° C., and even more preferably 200° C., and still more preferably 150° C., in terms of safety as a component placed in the vehicle cabin or near the vehicle cabin.

The Curie point of the material making up the outer peripheral wall 11 and the partition walls 12 can be adjusted by the type of shifter and an amount of the shifter added. For example, the Curie point of barium titanate (BaTIO₃) is about 120° C., but the Curie point can be shifted to the lower temperature side by substituting a part of Ba and Ti with one or more of Sr, Sn and Zr.

In the present invention, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from YHP). Based on an electrical resistance-temperature plot obtained by the measurement, a temperature at which the resistance value is twice the resistance value at room temperature (20° C.) is defined as the Curie point.

### (1-1-2. Thickness of Partition Wall 12 of Honeycomb Structure 10)

From the viewpoint of suppressing the initial current, it is advantageous to reduce the current path and increase the electrical resistance. Therefore, the thickness of the partition walls 12 in the honeycomb structure 10 is preferably 0.3 mm or less, and more preferably 0.25 mm or less, and even more preferably 0.2 mm or less. On the other hand, from the viewpoint of ensuring the strength of the honeycomb structure 10, the thickness of the partition walls 12 is preferably 0.02 mm or more, and more preferably 0.04 mm or more, and even more preferably 0.06 mm or more. The thickness of the partition walls 12 refers to a length of a line segment that crosses the partition wall 12 when connecting the centers of gravity of adjacent cells 14 in a cross section orthogonal to the flow path direction of the cell 14. The thickness of the partition walls 12 refers to an average thickness of all the partition walls 12.

From the viewpoint of reinforcing the honeycomb structure 10, the thickness of the outer peripheral wall 11 is preferably 0.05 mm or more, and more preferably 0.06 mm or more, and even more preferably 0.08 mm or more. However, the thickness of the outer peripheral wall 11 is preferably 1.0 mm or less, and more preferably 0.5 mm or less, and even more preferably 0.4 mm or less, and still more preferably 0.3 mm or less, from the viewpoints of increasing the electrical resistance, suppressing the initial current, and reducing the pressure loss when the gas passes through. The thickness of the outer peripheral wall 11 refers to a length from a boundary between the outer peripheral wall 11 and the outermost cell 14 or the partition wall 12 to a side surface of the honeycomb structure 10 in the normal direction of the side surface in the cross section orthogonal to the flow path of the cells 14.

### (1-1-3. Cell Density and Cell Pitch of Honeycomb Structure 10)

The cell density of the honeycomb structure 10 is preferably 93 cells/cm² or less, and more preferably 62 cells/cm² or less. Moreover, the cell pitch of the honeycomb structure 10 is preferably 1.0 mm or more, and more preferably 1.3 mm or more. By controlling the cell density or cell pitch to such a range, the air passing resistance can be suppressed and an output of a blower can be suppressed.

Although the lower limit of the cell density of the honeycomb structure 10 is not particularly limited, it may preferably be 10 cells/cm², and more preferably 20 cells/cm². The upper limit of the cell pitch of the honeycomb structure 10 is also not particularly limited, but it may preferably be 3.0 mm, and more preferably 2.0 mm.

The cell density of the honeycomb structure 10 is a value obtained by dividing the number of cells by the area of each end face of the honeycomb structure 10. Further, the cell pitch of the honeycomb structure 10 refers to a length of a line segment connecting the centers of gravity of two adjacent cells 14 on each end face of the honeycomb structure 10.

### (1-1-4. Volume Resistivity of Honeycomb Structure 10)

The honeycomb structure 10 (the outer peripheral wall 11 and the partition walls 12) has a volume resistivity of 0.5 to 1000 Ω·cm at room temperature (25° C.). The volume resistivity in such a range can be determined to be lower electrical resistance at room temperature. The lower electric resistance at room temperature can ensure heat generation performance required for heating, and can suppress an increase in power consumption. In particular, when the pair of electrode layers 20 are provided on the surface of the outer peripheral wall 11 of the honeycomb structure 10, a distance between the electrodes is larger than the case where the pair of electrode layers 20 are provided on the end faces (first end face 13a, second end face 13b) of the honeycomb structure 10. However, the volume resistivity in such a range can provide heat generation performance required for heating.

When the maximum voltage applied from a power supply is a higher voltage in the range of 100 V to 800 V, the volume resistivity of the honeycomb structure at room temperature (25° C.) is preferably 10 to 1000 Ω·cm. Further, when the maximum voltage applied from the power source is a lower voltage in the range of 12 V to 60 V, the volume resistivity of the honeycomb structure at room temperature (25° C.) is preferably 0.5 to 100 Ω·cm.

The volume resistivity of the honeycomb structure 10 can be measured as follows. Two or more samples each having a dimension of 30 mm×30 mm×15 mm are randomly cut and collected from the honeycomb structure 10. The electrical resistance at the measurement temperature is then measured by the two-terminal method, and the volume resistivity is calculated from shapes of the samples. An average value of the volume resistivities of all the samples is defined as a measured value at a measured temperature.

### (1-1-5. Opening Ratio of Honeycomb Structure 10)

The honeycomb structure 10 preferably has an opening ratio of 80% or more, and more preferably 85% or more. By controlling the opening ratio to the range, the pressure loss during gas passage can be suppressed.

Although the upper limit of the opening ratio of the honeycomb structure 10 is not particularly limited, it may preferably be 95%, and more preferably 90%. By controlling the opening ratio to the range, the strength of the honeycomb structure 10 can be maintained.

The opening ratio of the honeycomb structure 10 is determined by dividing the area of the cells 14 by the area of the entire cross section (the total area of the outer peripheral wall 11, the partition walls 12 and the cells 14) in the cross section orthogonal to the central axis X1 of the honeycomb structure 10, and expressing the resulting value as a percentage.

### (1-2. Electrode Layer 20)

The heater element 100 according to an embodiment of the present invention has a pair of electrode layers 20 arranged on the surface of the outer peripheral wall 11. The pair of electrode layers 20 are formed in a band shape extending parallel to the central axis X1 of the honeycomb structure 10. Further, the pair of electrode layers 20 are arranged on the surface of the outer peripheral wall 11 so as to face each other across the long axis X2 passing through the center of gravity of the honeycomb structure 10 in the cross section orthogonal to the central axis X1 of the honeycomb structure 10. By applying a voltage through the pair of electrode layers 20 thus arranged, heat can be generated in the honeycomb structure 10 by joule heat.

The electrode layer 20 that can be used herein includes, but not particularly limited to, a metal or alloy containing at least one selected from Cu, Ag, Al, Ni and Si. It is also possible to use an ohmic electrode layer capable of ohmic contact with the outer peripheral wall 11 and/or the partition walls 12, which has a PTC property. The ohmic electrode layer contains, for example, at least one selected from Au, Ag and In as a base metal, and contains at least one selected from Ni, Si, Ge, Sn, Se and Te for n-type semiconductors as a dopant. Further, the electrode layer 20 may have one layer or two or more layers. When the electrode layer 20 has two or more layers, materials of the respective layers may be of the same type or different types.

The thickness of each electrode 20 is not particularly limited, and it may be appropriately set according to the method for forming the electrode layers 20. The method for forming the electrode layers 20 includes metal deposition methods such as sputtering, vapor deposition, electrolytic deposition, and chemical deposition. Alternatively, the electrode layers 20 can be formed by applying an electrode paste and then baking it. Furthermore, the electrode layers 20 may be formed by thermal spraying.

It is preferable that the thickness of each electrode layer 20 is about 5 to 30 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition.

### (1-3. External Connecting Member 30)

The heater element 100 according to an embodiment of the present invention has an external connecting member 30 having a plate shape, which is arranged on an end portion side of each electrode layer 20 so as to be in plane contact with each electrode layer 20. By providing such a plate-shaped external connecting member 30 on each electrode layer 20, an amount of power supplied from the outside to the electrode layers 20 can be easily increased, so that the heat generation performance can be improved.

As used herein, “the end portion side of each electrode layer 20” means a region from the end of each electrode layer 20 up to 30% of the entire length of each electrode layer 20 in a direction of the long axis X2 passing through the center of gravity of the honeycomb structure 10.

The external connecting member 30 may be arranged on the end portion side of each electrode layer 20, and may not necessarily be in contact with the end of each electrode 20. For example, as shown in FIG. 4, the external connecting member 30 may be provided with a bent portion, and the bent portion may be connected to each electrode layer 20.

The external connecting member 30 preferably has the substantially same width as that of the end portion of the electrode layer 20 on the side where the external connecting member 30 is arranged. Such a configuration can increase a contact area of the electrode layer 20 with the external connecting member 30, so that the effect of improving the heat generation performance is enhanced.

As used herein, the phrase “substantially the same width as that of the end portion of the electrode layer 20” means that the width is within ±20% of the width of the end portion of the electrode layer 20.

It is preferable that each of the external connecting members 30 is arranged on one end portion side of the electrode layer 20 parallel to the central axis X1. One end portion side on which the external connecting member 30 is arranged may be the same side (e.g., FIGS. 1 to 5) or different side (e.g., FIG. 6) in the direction of the log axis X2 of the honeycomb structure 10. One end portion side is more preferably the same side. It is preferable that each of the external connecting members 30 extends outwardly from the end portion side in the same direction. Such a configuration can lead to a compact heater element 100 when the honeycomb structure 10 is applied to the heater element 100.

The external connecting member 30 may be made of, for example, a metal, although not limited thereto. The metal that can be used herein includes a single metal, an alloy, and the like. In terms of corrosion resistance, electrical resistance, and linear expansion rate, for example, the metal may preferably be an alloy containing at least one selected from the group consisting of Cr, Fe, Co, Ni, Cu, and Ti, and more preferably stainless steel, Fe—Ni alloys, and phosphorus bronze.

The shape and size of the external connecting member 30 are not particularly limited, but they may be appropriately adjusted according to the structure of the heater unit to be produced.

A method of connecting each external connecting member 30 to each electrode layer 20 is not particularly limited as long as they are electrically connected to each other. They may be connected by, for example, diffusion joining, a mechanical pressurizing mechanism, welding, or the like.

### (1-4. Method for Producing Heater Element 100)

Next, a method for producing a heater element 100 according to an embodiment of the invention will be exemplified.

When the material of the honeycomb structure 10 forming the heater element 100 is ceramics, a method for producing the honeycomb structure 10 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them. The green body may optionally contain additives such as shifters, metal oxides, property improving agents, and conductor powder.

The blending amount of the components other than the ceramic raw material is not particularly limited as long as the relative density of the honeycomb formed body is 60%.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total volume of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. In the extrusion, a die having a desired overall shape, cell shape, partition wall thickness, cell density and the like can be used.

The relative density of the honeycomb formed body obtained by extrusion is 60% or more, and preferably 61% or more. By controlling the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include conventionally known drying methods such as hot air drying, microwave drying, dielectric drying, drying under reduced pressure, drying in vacuum, and freeze drying. Among these, a drying method that combines the hot air drying with the microwave drying or dielectric drying is preferable in that the entire formed body can be rapidly and uniformly dried.

The firing step includes maintaining the ceramic formed body at a temperature of from 1150 to 1250° C., and then increasing the temperature to a maximum temperature of from 1360 to 1430° C. at a heating rate of 20 to 500° C./hour, and maintaining the temperature for 0.5 to 10 hours.

The maintaining of the honeycomb formed body at the maximum temperature of from 1360 to 1430° C. for 0.5 to 5 hours can provide the honeycomb structure 10 containing BaTiO₃-based crystal particles as a main component, in which a part of Ba is substituted with the rare earth element.

Further, the maintaining at the temperature of from 1150 to 1250° C. can allow the Ba₂TiO₄ crystal particles generated in the firing process to be easily removed, so that the honeycomb structure 10 can be densified.

Further, the heating rate of 20 to 500° C./hour from the temperature of 1150 to 1250° C. to the maximum temperature of 1360 to 1430° C. can allow 1.0 to 10.0% by mass of Ba₆Ti₁₇O₄₀ crystalline particles to be formed in the honeycomb structure 10.

The retention time at 1150 to 1250° C. is not particularly limited, but it may preferably be from 0.5 to 10 hours. Such a retention time can lead stable and easy removal of Ba₂TiO₄ crystalline particles generated in the firing step.

The firing step preferably includes maintaining at 900 to 950° C. for 0.5 to 5 hours. The maintaining at 900 to 950° C. for 0.5 to 5 hours can lead to sufficient decomposition of BaCO₃, so that the honeycomb structure 10 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of controlling electrical characteristics and production cost.

A firing furnace used in the firing step and the degreasing step is not particularly limited, but it may be an electric furnace, a gas furnace, or the like.

The electrode layers 20 are formed on a predetermined surface of the outer peripheral wall 11 of the honeycomb structure 10 thus obtained. The electrode layers 20 can be formed by the method as described above. The electrode layer 20 may be a single layer, or may be multiple layers having different compositions.

The external connecting members 30 are then connected to the electrode layers 20. As a method for connecting the electrode layers 20 to the external connecting members 30, the above method can be used.

### (1-5. Method for Using Heater Element 100)

The heater element 100 according to the embodiment of the present invention can generate heat by applying a voltage via the pair of electrode layers 20 from the external connecting members 30, for example. For the applied voltage, it is preferable to apply a voltage of 200 V or more, and it is more preferable to apply a voltage of 250 V or more, from the viewpoint of rapid heating.

When the heater element 100 generates heat due to the application of the voltage, the gas can be heated by allowing the gas to flow through the cells 14. A temperature of the gas flowing into the cells 14 can be, for example, −60° C. to 20° C., and typically −10° C. to 20° C.

By arranging the electrode layers 20 and the external connecting members 30 as described above, the heater element 100 according to the embodiment of the present invention can easily increase the amount of power supplied to the electrode layers 20 from the outside, thereby improving heat generation performance. Further, the heater element 100 according to the embodiment of the present invention has a simpler structure than that of an existing heater element in which a PTC element and an aluminum fin are integrated via an insulating ceramic plate, and can prevent the heater unit from becoming larger. Further, in the existing heater element, the PTC element is not in direct contact with the gas, resulting in an insufficient heating rate (heating time) of the gas, whereas in the heater element 100 according to the embodiment of the present invention, the honeycomb structure 10 in which the outer peripheral wall 11 and the partition walls 12 are made of a material having the PTC property is in direct contact with the gas, resulting in an increased heating rate of the gas.

In another aspect, the heater element according to the embodiment of the present invention can also be suitably used as a heater element for purifying a vehicle cabin of a vehicle.

Now, referring to FIG. 9, it shows a partially enlarged schematic cross-sectional view of the honeycomb structure 10 of the heater element used in this embodiment, which is orthogonal to the central axis.

As shown in FIG. 9, the heater element used in this embodiment further includes a functional material-containing layer 40 provided on the surfaces of the partition walls 12 of the honeycomb structure 10. With the heater element having such a configuration, air containing components to be removed such as water vapor, carbon dioxide, and odor components is allowed to flow through the cells 14, thereby trapping the components to be removed by the functional material-containing layer 40. It should be noted that the heater element used in this embodiment has the same structure as that of the heater element 100 described above, with the exception that the former further includes the functional material-containing layer 40, and so detailed descriptions thereof will be omitted.

Further, in the heater element used in this embodiment, the pair of electrode layers 20 are formed in the band shape extending parallel to the central axis X1, and are arranged on the surface of the outer peripheral wall 11 so as to face each other across the long axis X2 in the cross section orthogonal to the central axis X1 passes through the center of gravity of the honeycomb structure 10. Therefore, the honeycomb structure 10 can be uniformly heated as compared to a mode where the pair of electrode layers 20 are provided on both end faces (first end face 13a, second end face 13b) of the honeycomb structure 10, so that the functional material-containing layer 40 can be uniformly heated to effectively exhibit the function of the functional material. The reason why such an effect is produced is inferred as follows. In the heater element in which the pair of electrode layers 20 are provided on both end faces (first end face 13a and second end face 13b) of the honeycomb structure 10, a temperature of the honeycomb structure 10 on an inlet (e.g., first end face 13a) side is decreased when the air is fed from the inlet side of the honeycomb structure 10. As a result, the honeycomb structure 10 is not uniformly heated, and the functional material on the inlet side is not heated to its activation temperature, making it difficult for the functional material to exhibit its function. On the other hand, by providing the pair of electrode layers 20 on the surface (side surface) of the outer peripheral wall 11, the honeycomb structure 10 on the cold inlet side (for example, the first end face 13a) will have a lower resistance when a voltage lowered, resulting in concentration of current, while the relatively warm outlet side (for example, the second end face 13b) will have a higher resistance, resulting in restriction of the current. This would make it easier to uniformly heat the entire honeycomb structure 10, and the function of the functional material could be effectively exhibited.

The functional material contained in the functional material-containing layer 40 can include, but not particularly limited to, adsorbents, catalysts, and the like.

The functional material-containing layer 40 preferably contains the adsorbent, for example. By containing the adsorbent, the components to be removed from the air in the vehicle cabin can be captured.

The functional material-containing layer 40 can contain the catalyst. By using the catalyst, the components to be removed can be purified. For the purpose of enhancing the ability of the adsorbent to trap components to be removed, the adsorbent and the catalyst may be used together.

The adsorbent preferably has a function of adsorbing the components to be removed (e.g., water vapor, carbon dioxide, odor components), and more preferably has functions of adsorbing the components to be removed at −20 to 40° C. and releasing them at a high temperature of 60° C. or more. The adsorbents having such functions include zeolite, silica gel, activated carbon, alumina, silica, low-crystalline clay, amorphous aluminum silicate complexes, and the like. The type of adsorbent may be appropriately selected depending on types of components to be removed.

The catalyst preferably has a function capable of promoting the oxidation-reduction reaction. The catalysts having such functions include metal catalysts such as Pt, Pd and Ag, and oxide catalysts such as CeO₂ and ZrO₂.

The components to be removed, which are contained in the air in the vehicle cabin, are, for example, water vapor, carbon dioxide, and odor components. Specific examples of the odor components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

In the honeycomb structure 10 of the heater element used in this embodiment, the thickness of the partition walls 12 is preferably 0.125 mm or less, and more preferably 0.10 mm or less, and still more preferably 0.08 mm or less, from the viewpoint of supporting a sufficient amount of the functional material on the honeycomb structure 10. From the same viewpoint, the cell density is preferably 100 cells/cm² or less, and more preferably 70 cells/cm² or less, and still more preferably 65 cells/cm² or less, and the cell pitch is preferably 1.0 mm or more, and more preferably 1.2 mm or more, and still more preferably 1.3 mm or more.

### (2. Heater Unit)

The heater unit according to an embodiment of the present invention can be suitably used as a heater unit for heating a vehicle cabin of a vehicle. In particular, since the heater unit according to the embodiment of the present invention uses the heater element 100 having higher heat generation performance, the heat generation performance of the heater unit can be improved. Further, since the heater element 100 can be made compact, it is possible to prevent the heater unit from becoming larger.

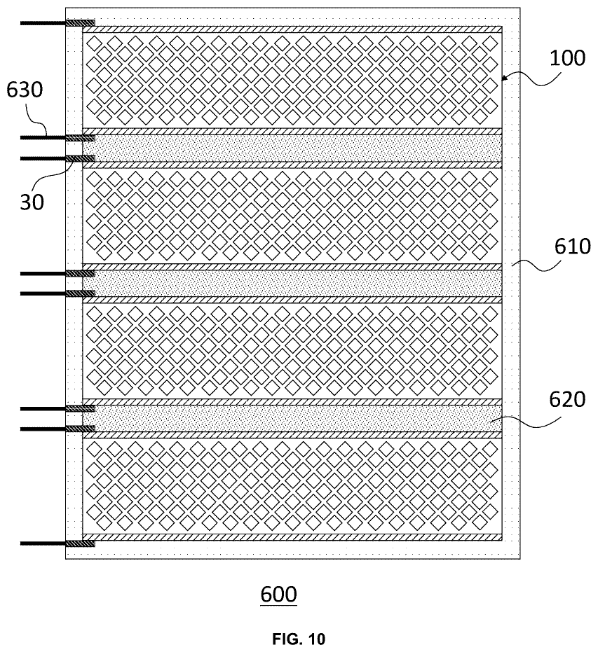

FIG. 10 is a schematic front view of a heater unit according to an embodiment of the present invention as viewed from the first end face side of the heater element.

As shown in FIG. 10, a heater unit 600 according to an embodiment of the present invention includes two or more heater elements 100. Further, in the heater unit 600, the heater elements 100 are stacked so that the surfaces of the outer peripheral walls 11 of the honeycomb structures 10 including the long sides 16 of the first end faces 13a and the second end faces 13b are opposed to each other. Such a configuration can produce a compact heater unit 600.

The heater unit 600 according to the embodiment of the present invention may further include a housing (housing member) 610.

The housing 610 may be made of any material, including, but not limited to, for example, metals and resins. Among them, the material of the housing 610 is preferably the resin. The housing 610 made of the resin can suppress electric shock without grounding.

The shape and size of the housing 610 are not particularly limited, but they may be the same as those of the existing heater unit.

The heater unit 600 according to the embodiment of the present invention may further include insulating materials 620 each arranged between the heater elements 100 which are stacked. Such a configuration can suppress an electrical short circuit between the plurality of heater elements 100.

The insulating materials 620 that can be used herein include plate materials, mats, clothes, and the like, which are formed of an insulating material such as alumina or ceramics.

The heater unit 600 according to the embodiment of the present invention has a wiring structure capable of controlling the heater elements 100. More particularly, the heater unit 600 according to the embodiment of the present invention may further include wirings 630 connected to the external connecting members 30 of the heater element 100.

The wiring structure is not particularly limited, but as shown in FIG. 10, it may be a wiring structure in which each of the heater elements 100 is independently controllable. More particularly, the wiring 630 can be connected to each of the external connecting members 30 of the heater element 100. The wirings 630 are connected to an external power source (not shown). Such a wiring structure can allow the heater elements 100 to be each independently controlled, thereby enabling fine temperature tuning.

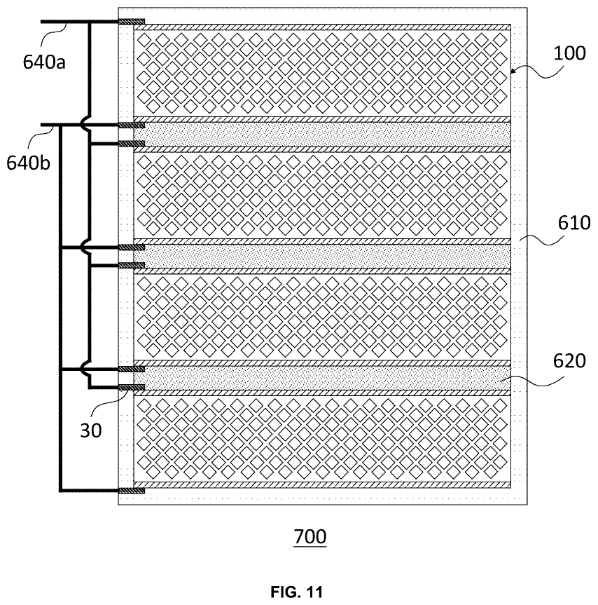

As shown in FIG. 11, the wiring structure may be a parallel wiring structure in which two or more heater elements 100 can be collectively controlled. More particularly, the parallel wiring 640a may be connected to one of the external connecting members 30 of each heater element 100, and one parallel wiring 640b may be connected to the other external connecting member 30. Such a wiring structure can suppress the power consumption of the heater unit 700.

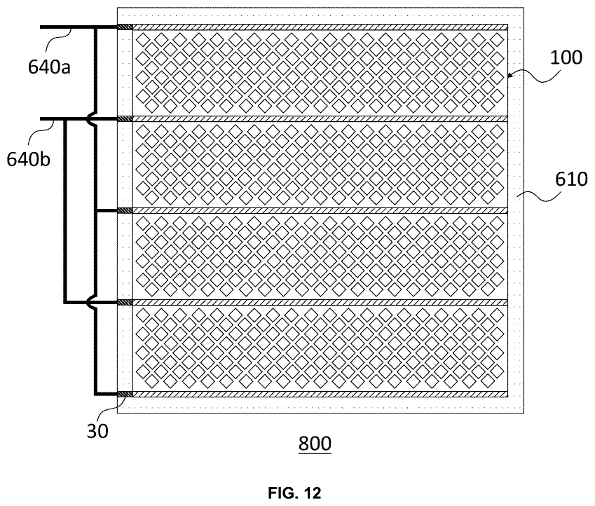

Further, as shown in FIG. 12, it may be a parallel wiring structure where two or more heater elements 100 can be collectively controlled using the electrode layers 20 between the stacked heater elements 100 as one electrode layer 20 common to the stacked heater elements 100. More particularly, each external connecting member 30 may be arranged at the end of each electrode layer 20, the parallel wiring 640a may be connected to one of the external connecting members 30 of each heater element 100, and one parallel wiring 640b may be connected to the other external connecting member 30. Such a structure can eliminate necessity to arrange the insulating material 620 between the stacked heater elements 100, so that the heater unit 800 can be made compact and the power consumption can be suppressed.

### (3. Heater System)

The heater system according to an embodiment of the present invention can be suitably used as a heater system for heating a vehicle cabin of a vehicle. Especially, in the heater system according to the embodiment of the present invention, the heater unit 600 having high heat generation performance is used, so that the heat generation performance of the heater system can be improved. Further, the heater unit 600 can be made compact, so that it is possible to prevent the heater system from becoming larger. It should be noted that heater units 700, 800 may be used in place of the heater unit 600.

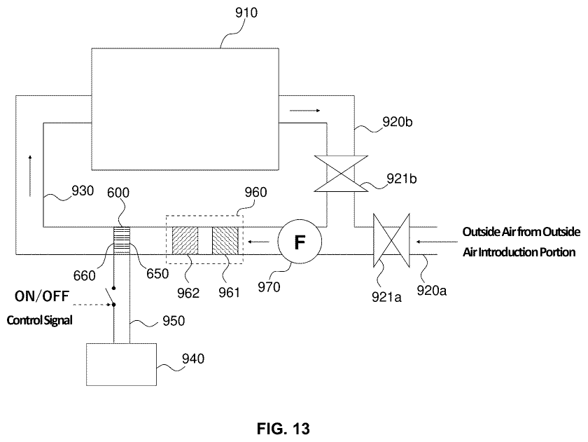

FIG. 13 is a schematic view showing an arrangement example of a heater system according to an embodiment of the present invention.

As shown in FIG. 13, a heater system 900 according to the embodiment of the present invention includes: the heater unit 600 according to the embodiment of the present invention; inflow pipes 920a, 920b for communicating an outside air introduction portion or a vehicle cabin 910 with an inflow port 650 of the heater unit 600; a battery 940 for applying a voltage to the heater unit 600; and an outflow pipe 930 for communicating an outflow port 660 of the heater unit 600 with the vehicle cabin 910.

The heater unit 600 can be configured to energize and generate heat by connecting to the battery 940 with an electric wire 950 and turning on a power switch in the middle of the wiring, for example.

Disposed on the upstream side of the heater unit 600 can be a vapor compression heat pump 960. In the heater system 900, the vapor compression heat pump 960 is configured as a main heating device, and the heater unit 600 is configured as an auxiliary heater. The vapor compression heat pump 960 can be provided with a heat exchanger including: an evaporator 961 that functions to absorb heat from the outside during cooling to evaporate a refrigerant; and a condenser 962 that functions to liquefy a refrigerant gas to release heat to the outside during heating. The vapor compression heat pump 960 is not particularly limited, and a vapor compression heat pump known in the art can be used.

On the upstream side and/or the downstream side of the heater unit 600, a blower 970 can be installed. In terms of ensuring safety by arranging high-voltage parts as far as possible from the vehicle cabin 910, the blower 970 is preferably installed on the upstream side of the heater unit 600. As the blower 970 is driven, air flows into the heater unit 600 from the inside or outside of the vehicle cabin 910 through the inflow pipes 920a, 920b. The air is heated while passing through the heating unit 600 that is generating heat. The heated air flows out from the heater unit 600 and is delivered into the vehicle cabin 910 through the outflow pipe 930. The outlet of the outflow pipe 930 may be arranged near the feet of an occupant so that the heating effect is particularly high even in the vehicle cabin 910, or the pipe outlet may be arranged in a seat to warm the seat from the inside, or may be arranged near a window to have an effect of suppressing fogging of the window.

The inflow pipe 920a and the inflow pipe 920b merge in the middle. The inflow pipe 920a and the inflow pipe 920b can be provided with valves 921a and 921b, respectively, on the upstream side of the confluence. By controlling the opening and closing of the valves 921a, 921b, it is possible to switch between a mode where the outside air is introduced into the heater unit 600 and a mode where the air in the vehicle cabin 910 is introduced into the heater unit 600. For example, the opening of the valve 921a and the closing of the valve 921b results in the mode where the outside air is introduced into the heater unit 600. It is also possible to open both the valve 921a and the valve 921b to introduce the outside air and the air in the vehicle cabin 910 into the heater unit 600 at the same time.

### EXAMPLES

Hereinafter, the present invention will be described in more detail with reference to Examples, but the present invention is not limited to these Examples.

### Example 1

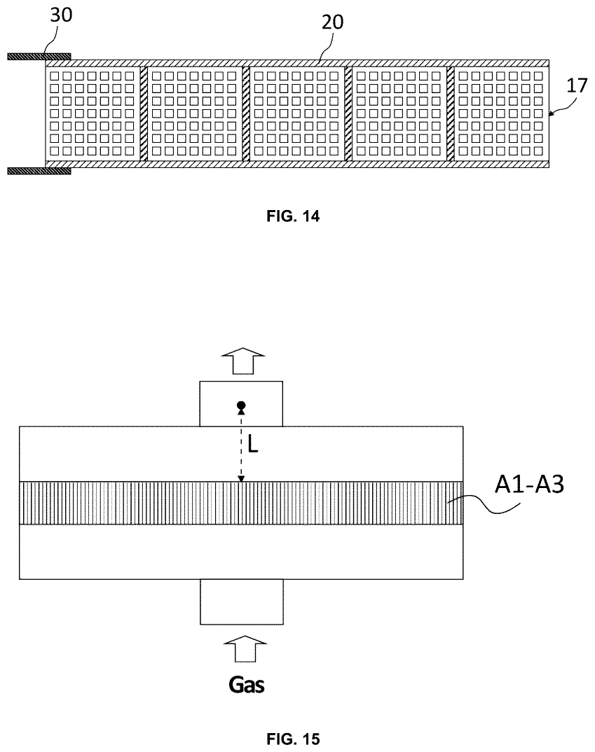

A heater element A1 in which the cross section orthogonal to the central axis of the honeycomb joined body had the shape as shown in FIG. 14 was produced. Specifically, the heater element A1 was produced as follows:

As ceramic raw materials, BaCO₃ powder, TiO₂ powder and La(NO₃)₃·6H₂O powder were prepared. These powders were weighed so as to have the predetermined composition after firing, and dry-mixed to obtain a mixed powder. The dry mixing was carried out for 30 minutes. Subsequently, from 3 to 30 parts by weight of water, a binder, a plasticizer and a dispersant in total were added by a proper amount, based on 100 parts by mass of the obtained mixed powder, such that a ceramic formed body having a relative density of 64.8% were obtained after extrusion, and then kneaded to obtain a green body. Methyl cellulose was used as the binder. Polyoxyalkylene alkyl ether was used as the plasticizer and the dispersant.

Each green body was introduced into an extrusion molding machine and extruded using a predetermined die so as to form a honeycomb segment in which the cross section orthogonal to the central axis had the shape as shown in FIG. 14 after firing, thereby obtaining a honeycomb formed body (having dimensions of 32 mm×32 mm×14 mm after firing). The density of the honeycomb formed body was then measured according to the above method.

Subsequently, the obtained honeycomb formed body was subjected to dielectric drying and hot air drying, and then degreased in an air atmosphere (450° C. for 4 hours) in a firing furnace, and then fired in an air atmosphere to obtain a honeycomb segment. The firing was sequentially carried out by maintaining at 950° C. for 1 hour, increasing a temperature to 1200° C., maintaining at 1200° C. for 1 hour, increasing the temperature to 1400° C. (maximum temperature) at 200° C./hour, and maintaining at 1400° C. for 2 hours.

Details of the obtained honeycomb segment are as follows:
Content of BaTiO₃-based crystalline particles: 95.0% by mass;
Content of Ba₆Ti₁₇O₄₀ crystalline particles: 4.0% by mass;
Content of BaCO₃ crystalline particles: 1.0% by mass;
La atomic ratio (x value) of BaTiO₃-based crystalline particles: 0.001;
(Ba+La)/Ti ratio of BaTiO₃-based crystalline particles: 1.030; and
Average crystal grain size of BaTiO₃-based crystalline particles: 20 μm.

In addition, the content of each crystalline particle was identified using an X-ray diffractometer. As the X-ray diffractometer, a multifunctional powder X-ray diffractometer (D8Avance from Bruker) was used. The conditions for the X-ray diffraction measurement were: a CuKα radiation source; 10 kV; 20 mA; 2θ=5 to 100°. The obtained X-ray diffraction data was then analyzed by the Rietveld method using an analysis software TOPAS (from BrukerAXS) to identify the crystalline particles.

The content of each crystalline particle was measured using an X-ray diffractometer. As the X-ray diffractometer, the same equipment and analysis software as described above were used, and the content of each crystal particle was determined by the Rietveld method.

The chemical composition of the ceramics was analyzed by ICP emission spectroscopy to determine atomic ratios of elements such as La, Ba and Ti.

The average crystal grain size of ceramics was measured according to the above method. The SEM observation was performed using model S-3400N manufactured by Hitachi High-Technologies Corporation at an acceleration voltage of 15 kV and at magnifications of 3000.

The above measurement conditions were the same for the following Examples.

Five of the above honeycomb segments were then prepared, and a joining material was applied to the side surfaces of the honeycomb segments and joined to each other to obtain a honeycomb joined body. As the joining material, a paste made by adding a solvent such as water to a ceramic material was used.

The details of the obtained honeycomb joined body are as follows. It should be noted that the physical property values were measured by the methods as described above.
Shape of the honeycomb joined body in the cross section orthogonal to the central axis: rectangular;
Shape of each cell in the cross section orthogonal to the central axis: square;
Thickness of partition walls: 0.10 mm;
Cell density: 64 cells/cm²;
Cell pitch: 1.27 mm;
Cross section orthogonal to the cell extending direction: 32 mm×180 mm;
Length in the cell extending direction: 14 mm;
End face area: 57.6 cm²;
Angles of the partition walls relative to the long axis: 0° and 90°;
Volume resistivity at room temperature (25° C.): 140 cm;
Opening ratio: 85%; and
Curie point: 120° C.

Next, electrode layers were formed on both sides of the outer peripheral wall including the long sides of the rectangular cross section of the honeycomb joined body. As for the electrode layers, first, an Al—Ni electrode paste was applied to both sides of the outer peripheral wall, and a silver electrode paste was then applied and baked at 700° C. to form Al—Ni electrode layers and silver electrode layers.

A plate-shaped external connecting member made of phosphor bronze was connected to one end of each electrode layer to obtain a heater element A1.

### Example 2

A heater element A2 was produced by the same method as that of Example 1, with the exception that a honeycomb joined body having the shape as shown in FIG. 8 was used as the honeycomb joined body. Specifically, the heater element A2 was produced as follows:

As ceramic raw materials, BaCO₃ powder, TiO₂ powder and La(NO₃)₃·6H₂O powder were prepared. These powders were weighed so as to have the predetermined composition after firing, and dry-mixed to obtain a mixed powder. The dry mixing was carried out for 30 minutes. Subsequently, from 3 to 30 parts by weight of water, a binder, a plasticizer and a dispersant in total were added by a proper amount, based on 100 parts by mass of the obtained mixed powder, such that a ceramic formed body having a relative density of 63.6% was obtained after extrusion, and then kneaded to obtain a green body. Methyl cellulose was used as the binder. Polyoxyalkylene alkyl ether was used as the plasticizer and the dispersant.

Each green body was introduced into an extrusion molding machine and extruded using a predetermined die so as to form a honeycomb segment in which the cross section orthogonal to the central axis had the shape as shown in FIG. 8 after firing, thereby obtaining a honeycomb formed body (having dimensions of 32 mm×32 mm×14 mm after firing). The density of the honeycomb formed body was measured according to the above method.

Subsequently, the obtained honeycomb formed body was subjected to dielectric drying and hot air drying, and then degreased in an air atmosphere (450° C. for 4 hours) in a firing furnace, and then fired in an air atmosphere to obtain a honeycomb segment. The firing was sequentially carried out by maintaining at 950° C. for 1 hour, increasing a temperature to 1200° C., maintaining at 1200° C. for 1 hour, increasing the temperature to 1400° C. (maximum temperature) at 50° C./hour, and maintaining at 1400° C. for 2 hours.

Details of the obtained honeycomb segment are as follows:
Content of BaTiO₃-based crystalline particles: 97.3% by mass;
Content of Ba₆Ti₁₇O₄₀ crystalline particles: 3.9% by mass;
Content of BaCO₃ crystalline particles: 1.0% by mass;
La atomic ratio (x value) of BaTiO₃-based crystalline particles: 0.002;
(Ba+La)/Ti ratio of BaTiO₃-based crystalline particles: 1.010; and
Average crystal grain size of BaTiO₃-based crystalline particles: 8 μm.

Five of the above honeycomb segments were then prepared, and a joining material was applied to the side surfaces of the honeycomb segments and joined to each other to obtain a honeycomb joined body as shown in FIG. 8. As for the joining material, a paste made by adding a solvent such as water to a ceramic material was used.

The details of the obtained honeycomb joined body are as follows. It should be noted that the physical property values were measured by the methods as described above.
Shape of the honeycomb joined body in the cross section orthogonal to the central axis: rectangular;
Shape of each cell in the cross section orthogonal to the central axis: square;
Thickness of partition walls: 0.10 mm;
Cell density: 64 cells/cm²;
Cell pitch: 1.27 mm;
Cross section orthogonal to the cell extending direction: 32 mm×180 mm;
Length in the cell extending direction: 14 mm;
End face area: 57.6 cm²;
Angle of the partition wall relative to the long axis: 45°;
Volume resistivity at room temperature (25° C.): 30 Ωcm;
Opening ratio: 85%; and
Curie point: 120° C.

Next, electrode layers were formed on both sides of the outer peripheral wall including the long sides having the rectangular cross section of the honeycomb joined body. As for the electrode layers, first, an A1-Ni electrode paste was applied to both sides of the outer peripheral wall, and a silver electrode paste was then applied and baked at 700° C. to form A1-Ni electrode layers and silver electrode layers.

A plate-shaped external connecting member made of phosphor bronze was connected to one end of each electrode layer to obtain a heater element A2.

### Example 3

Using the same green body as that of Example 1, a heater element A3 in which the cross section orthogonal to the central axis of the honeycomb structure has the shape as shown in FIG. 2 was produced. Specifically, the heater element A3 was produced as follows:

A honeycomb structure was obtained under the same conditions as those of Example 1, with the exception that the honeycomb structure was extruded so that the cross section orthogonal to the central axis had the shape as shown in FIG. 2.

The details of the obtained honeycomb structure are as follows. It should be noted that the physical property values were measured by the methods as described above.
Shape of the honeycomb structure in the cross section orthogonal to the central axis: rectangular;
Shape of each cell in the cross section orthogonal to the central axis: square;
Thickness of partition walls: 0.13 mm;
Cell density: 64 cells/cm²;
Cell pitch: 1.30 mm;
Cross section orthogonal to the cell extending direction: 32 mm×175 mm;
Length in the cell extending direction: 14 mm;
End face area: 57.6 cm²;
Angle of the partition wall relative to the long axis: 45°;
Volume resistivity at room temperature (25° C.): 14 Ωcm;
Opening ratio: 85%; and
Curie point: 120° C.

Next, electrode layers were formed on both sides of the outer peripheral wall including the long sides having the rectangular cross section of the honeycomb structure. As for the electrode layers, first, an Al—Ni electrode paste was applied to both sides of the outer peripheral wall, and a silver electrode paste was then applied and baked at 700° C. to form Al—Ni electrode layers and silver electrode layers.

A plate-shaped external connecting member made of phosphor bronze was connected to one end of each electrode layer to obtain a heater element A3.

### (Evaluation of Heater Element)

The heater elements A1 and A2 obtained above were placed in an evaluation box having an inflow port and an outflow port for a gas, as shown in FIG. 15. An electrical heating test was conducted by applying 200 V to the heater elements A1 and A2 while flowing the gas into the evaluation box from the inflow port for the gas at 400 L/min.

In the electrical heating test, the temperature of the gas at the outflow port for the gas was measured. The measurement point was a position where a distance L to the ends of the heater elements A1 and A2 was 100 mm.

As a result, the heater element A1 reached 60° C. in 10 seconds. Also, the heater element A2 reached 80° C. in 10 seconds.

The same test was conducted at a gas flow rate of 400 L/min and at an applied voltage of 200 V for the heater element A3. As a result, the temperature reached 80° C. in 10 seconds.

Further, in the electrical heating test, one cycle consisted of electrical heating for one hour and cooling for 30 minutes by circulating the gas at room temperature (25° C.), and the resistance value between the external connecting members was measured after 100 cycles. As a result, the resistance value of the heater element A1 was increased twice, from the initial value (100Ω) to 200Ω, while the resistance value of the heater element A2 remained at 100Ω.

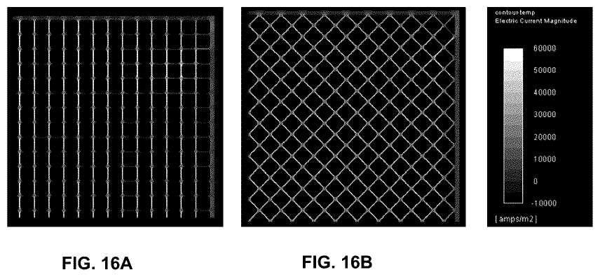

Furthermore, at 2.5 seconds after the voltage was applied during the electrical heating test, the current density distribution of the honeycomb joined body was estimated in a cross section at a position of 1 mm from the end face of the honeycomb joined body forming the heater elements A1 and A2. The results are shown in FIGS. 16A and 16B. FIG. 16A shows the results of the current density distribution of the honeycomb structure of the heater element A1, and FIG. 16B shows the results of the current density distribution of the honeycomb structure of the heater element A2.

As shown in FIGS. 16A and 16B, in the honeycomb joined body of the heater element A2, the current flowed to all the partition walls in a generally uniform manner, whereas, in the honeycomb joined body of the heater element A1, the current was concentrated at the partition walls at 90° relative to the long axis, and the current did not sufficiently flow in the partition walls at 0° (parallel) to the long axis. Therefore, it is believed that the heater element A2 can heat the honeycomb joined body more uniformly than the heater element A1.

Further, as a result of continuous application of electric power in the electrical heating test, deformation and cracking occurred in the partition walls near the electrode layers on the heater element A1, whereas such deformation and cracking did not occur for the heater element A2. Therefore, it is believed that the heater element A2 can further suppress deformation and cracking of the partition walls of the honeycomb structure.

As can be seen from the above results, according to the present invention, it is possible to provide a heater element for heating a vehicle cabin, which can increase an amount of power supplied from the outside and improve heat generation performance, as well as a heater unit and a heater system for heating a vehicle cabin using that heater element. Also, according to the present invention, it is possible to provide a heater element which can also be used for purifying a vehicle cabin.

### DESCRIPTION OF REFERENCE NUMERALS

10 honeycomb structure
11 outer peripheral wall
12 partition wall
13a first end face
13b second end face
14 cell
15 short side
16 long side
17 honeycomb joined body
18 honeycomb segment
19 Joining layer
20 electrode layer
30 external connecting member
40 functional material-containing layer
100, 200, 300, 400, 500 heater element
600 heater unit
610 housing
620 insulating material
630 wiring
640a, 640b parallel wiring
650 inflow port
660 outflow port
700, 800 heater unit
900 heater system
910 vehicle cabin
920a, 920b inflow pipe
921a, 921b valve
930 outflow pipe
940 battery
950 electric wire
960 vapor compression heat pump
961 evaporator
962 condenser
970 blower
X1 central axis
X2 long axis
X3 short axis

1. A heater element for heating a vehicle cabin, comprising:
a honeycomb structure comprising: an outer peripheral wall; and partition walls disposed on an inner side of the outer peripheral wall, the partition walls defining a plurality of cells each forming a flow path from a first end face to a second end face, the outer peripheral wall and the partition walls comprising a material having a PTC property; and
a pair of electrode layers provided on a surface of the outer peripheral wall,
wherein the honeycomb structure has a shape having a long axis and a short axis in a cross section orthogonal to a central axis,
wherein the pair of electrode layers are formed in a band shape extending parallel to the central axis, and are arranged on the surface of the outer peripheral wall so as to face each other across the long axis passing through a center of gravity of the honeycomb structure in the cross section orthogonal to the central axis, and
wherein the heater element further comprises a plate-shaped external connecting member disposed on an end portion side of each of the electrode layers, the plate-shaped external connecting member being in plane contact with each of the electrode layers.

2. The heater element according to claim 1, wherein the external connecting member has substantially the same width as that of an end portion of the electrode layer on which the external connecting member is arranged.

3. The heater element according to claim 1, wherein each of the external connecting members is arranged on one end portion side of the electrode layer parallel to the central axis, and extends outwardly from the end portion side in the same direction.

4. The heater element according to claim 1, wherein the honeycomb structure has a rectangular cross section orthogonal to the central axis, and the pair of electrode layers are disposed on both sides of the outer peripheral wall including long sides of the rectangular cross section.

5. The heater element according to claim 4, wherein the rectangular cross section has a ratio of a short side length to a long side length of 1:2 to 1:15.

6. The heater element according to claim 1, wherein the honeycomb structure does not have partition walls parallel to the long axis in the cross section orthogonal to the central axis.

7. The heater element according to claim 1, wherein the honeycomb structure has an angle of each of the partition walls relative to the long axis of 30 to 60° in the cross section orthogonal to the central axis.

8. The heater element according to claim 1, wherein the partition walls of the honeycomb structure define a hexagonal cell shape in the cross section orthogonal to the central axis.

9. The heater element according to claim 1, wherein the honeycomb structure has a thickness of the partition walls of 0.3 mm or less, a cell density of 93 cells/cm² or less, and a cell pitch of 1.0 mm or more.

10. The heater element according to claim 1, wherein the outer peripheral wall and the partition walls have a volume resistivity of 0.5 to 1000 Ω·cm at room temperature.

11. The heater element according to claim 1, wherein the outer peripheral wall and the partition walls are made of a material containing barium titanate as a main component, the material being substantially free of lead.

12. The heater element according to claim 1, wherein the honeycomb structure is a honeycomb joined body having two or more honeycomb segments and joining layers for joining the honeycomb segments to each other.

13. The heater element according to claim 1, wherein the honeycomb structure has an opening ratio of 80% or more.

14. A heater unit for heating a vehicle cabin, the heater unit comprising two or more of the heater elements according to claim 1,
wherein the heater elements are stacked so that surfaces of the outer peripheral walls of the honeycomb structures, including long sides of the first end faces and the second end faces, are opposed to each other.

15. The heater unit according to claim 14, further comprising an insulating material arranged between the stacked heater elements, wherein the heater unit has a wiring structure capable of independently controlling each of the heater elements.

16. The heater unit according to claim 14, further comprising an insulating material arranged between the stacked heater elements, wherein the heater unit has a parallel wiring structure capable of collectively controlling two or more of the heater elements.

17. The heater unit according to claim 14, wherein the electrode layer between the stacked heater elements is one electrode layer common to the stacked heater elements, and the heater unit has a parallel wiring structure capable of collectively controlling two or more of the heater elements.

18. A heater system for heating a vehicle cabin, comprising:
the heater unit according to claim 14;
an inflow pipe for communicating an outside air introduction portion or a vehicle cabin with an inflow port of the heater unit;
a battery for applying voltage to the heater unit; and
an outflow pipe for communicating an outflow port of the heater unit with the vehicle cabin.

19. A heater element for purifying a vehicle cabin, comprising:
a honeycomb structure comprising: an outer peripheral wall; and partition walls disposed on an inner side of the outer peripheral wall, the partition walls defining a plurality of cells each forming a flow path from a first end face to a second end face, the outer peripheral wall and the partition walls comprising a material having a PTC property;
a pair of electrode layers provided on a surface of the outer peripheral wall; and
a functional material-containing layer provided on surfaces of the partition walls,
wherein the honeycomb structure has a shape having a long axis and a short axis in a cross section orthogonal to a central axis,
wherein the pair of electrode layers are formed in a band shape extending parallel to the central axis, and are arranged on the surface of the outer peripheral wall so as to face each other across the long axis passing through a center of gravity of the honeycomb structure in the cross section orthogonal to the central axis, and
wherein the heater element further comprises a plate-shaped external connecting member disposed on an end portion side of each of the electrode layers, the plate-shaped external connecting member being in plane contact with each of the electrode layers.

20. The heater element according to claim 19, wherein the functional material-containing layer comprises a functional material having a function of adsorbing one or more selected from water vapor, carbon dioxide and odor components.
